(19) United States
(12) Patent Application Publication
(10) Pub. No.: US 2026/0357986 A1
(43) Pub. Date: Nov. 12, 2026

(54) GAS TURBINE COMBUSTOR AND GAS TURBINE

(71) Applicant: MITSUBISHI HEAVY INDUSTRIES, LTD., Tokyo (JP)

(72) Inventors: Taku EGAWA, Tokyo (JP); Tomo KAWAKAMI, Tokyo (JP); Kenta TANIGUCHI, Tokyo (JP); Keisuke MIURA, Tokyo (JP); Shinichi FUKUBA, Tokyo (JP); Hiroyuki TATE, Tokyo (JP); Keita YUNOKI, Tokyo (JP)

(21) Appl. No.: 19/488,741

(22) PCT Filed: May 16, 2024
(86) PCT No.: PCT/JP2024/018174

§ 371 Date: Nov. 28, 2025

(30) Foreign Application Priority Data
Jun. 13, 2023 (JP) 2023-097170

(51) Int. Cl. F23R 3/10; F23R 3/00; F23R 3/28

(52) U.S. Cl. CPC F23R 3/10; F23R 3/002; F23R 3/28

(57) ABSTRACT

A gas turbine combustor including: a combustion cylinder having a combustion chamber; an airhole plate, with a plurality of airholes extending in the axial direction of the cylinder, and located upstream of the chamber; a cylindrical member having an internal space extending in the axial direction, and located on the side opposite the cylinder with respect to the airhole plate; and a top hat section having a head end section located on the side opposite the airhole plate with respect to the cylindrical member. The cylindrical member includes an opening formed in a side section of the cylindrical member for drawing air within a combustor compartment into an internal space. When the top hat section is attached to a casing demarcating the combustor compartment, at least part of the opening section is located further into the interior of the combustor compartment than the inner peripheral surface of the casing.

### TECHNICAL FIELD

The present disclosure relates to a gas turbine combustor and a gas turbine.

The present application claims the benefit of priority based on Japanese Patent Application No. 2023-097170 filed to the Japanese Patent Office on Jun. 13, 2023, the content of which is incorporated herein by reference.

### BACKGROUND ART

Due to social demands for reducing environmental loads, in recent years, a reduction in an NOx emission amount has also been emphasized in the development of gas turbine combustors. Uniform dispersion combustion is known as one method of reducing the NOx emission amount. The uniform dispersion combustion is a method in which each of fuel and air is supplied to a combustion chamber in a uniformly dispersed manner to be combusted, and can reduce the NOx emission amount through suppression of the occurrence of a local high-temperature region. Many gas turbine combustors that employ the uniform dispersion combustion have been proposed, and, for example, a gas turbine combustor is known in which a large number of fuel nozzles are included and a large number of air holes are coaxially disposed with each nozzle (refer to PTL 1 and the like).

### CITATION LIST

### Patent Literature

[PTL 1] Japanese Unexamined Patent Application Publication No. 2003-148734

### SUMMARY OF INVENTION

### Technical Problem

In a gas turbine combustor, a configuration is often employed in which a cylindrical outer peripheral flow path is provided on an outer periphery of an inner cylinder (combustion liner) and compressed air from a compressor is caused to flow through the outer peripheral flow path to cool the inner cylinder. The compressed air passing through the outer peripheral flow path is turned back at an end portion of the combustor, and is supplied to the combustion chamber to be combusted together with the fuel.

However, in the structure in which the air flow path is turned back at the end portion of the combustor in this manner, in a case where a size of an outer cylinder disposed on the outer periphery of the inner cylinder cannot be increased, a flow path cross-sectional area of the outer peripheral flow path is small. For this reason, a flow speed at a turning-back portion of the air flow path is high, and the compressed air may be separated at the turning-back portion, which may result in a variation in an air flow rate of the compressed air flowing into the air hole. A variation also occurs in a fuel-air ratio between the air holes in a case where the variation occurs in the air flow rate, and a flame temperature locally rises in a region where a fuel concentration is high, which is a factor of an increase in the NOx emission amount. Further, the separation of the compressed air increases a pressure loss, which may lead to a decrease in the efficiency of the entire gas turbine. Thus, a suppression of the separation of the compressed air to improve a bias of the air flow rate between the air holes is an important issue in the uniform dispersion combustion.

In view of the above circumstances, an object of at least one embodiment of the present disclosure is to provide a gas turbine combustor and a gas turbine capable of suppressing separation of compressed air to reduce a bias in an air flow rate between air holes.

### Solution to Problem

(1) According to at least one embodiment of the present disclosure, there is provided a gas turbine combustor including
a combustion cylinder that has a combustion chamber on an inner side of the combustion cylinder;
an air hole plate that is formed with a plurality of air holes extending in an axial direction of the combustion cylinder and that is located on an upstream side of the combustion cylinder;
a tubular member that has an internal space extending in the axial direction inside and that is located on a side opposite to the combustion cylinder with respect to the air hole plate; and
a top hat portion that has a head end portion located on a side opposite to the air hole plate with respect to the tubular member,
in which the tubular member includes an opening that is formed in a side portion of the tubular member and that is for taking in air in a combustor casing into the internal space, and
at least a part of the opening is configured to be located, in a case where the top hat portion is attached to a casing defining the combustor casing, more inside the combustor casing than an inner peripheral surface of the casing.
(2) According to at least one embodiment of the present disclosure, there is provided a gas turbine including
the gas turbine combustor having a configuration of (1); and
the casing defining the combustor casing.

### Advantageous Effects of Invention

According to at least one embodiment of the present disclosure, it is possible to reduce the bias in the air flow rate between the air holes.

### BRIEF DESCRIPTION OF DRAWINGS

FIG. 1 is a schematic configuration diagram of a gas turbine according to one embodiment.

FIG. 2 is a cross-sectional view of a vicinity of a combustor.

FIG. 3 is a diagram for describing a structure of main parts of the combustor according to some embodiments.

FIG. 4 is a cross-sectional view of an air hole plate of the combustor according to another embodiment.

### DESCRIPTION OF EMBODIMENTS

Hereinafter, some embodiments of the present disclosure will be described with reference to accompanying drawings. Dimensions, materials, shapes, relative dispositions, and the like of components described as embodiments or illustrated in the drawings are not intended to limit the scope of the present disclosure, but are merely explanatory examples.

For example, an expression representing a relative or absolute disposition such as “in certain direction”, “along certain direction”, “parallel”, “orthogonal”, “center”, “concentric”, or “coaxial” not only represents such a disposition strictly, but also represents a state in which there is a tolerance or relative displacement with an angle or a distance to the extent that the same function can be obtained.

For example, expressions such as “identical”, “equal”, and “homogeneous”, which indicate that things are in the same state, not only represent a state of being strictly equal, but also represent a state in which there is a tolerance or a difference to the extent that the same function can be obtained.

For example, an expression representing a shape such as a quadrangular shape or a cylindrical shape not only represents a shape such as a quadrangular shape or a cylindrical shape in a geometrically strict sense, but also represents a shape including a convex portion, a chamfered portion, or the like within a range in which the same effect can be obtained.

Meanwhile, an expression such as “being provided with”, “comprising”, “including”, or “having” one component is not an exclusive expression excluding the presence of another component.

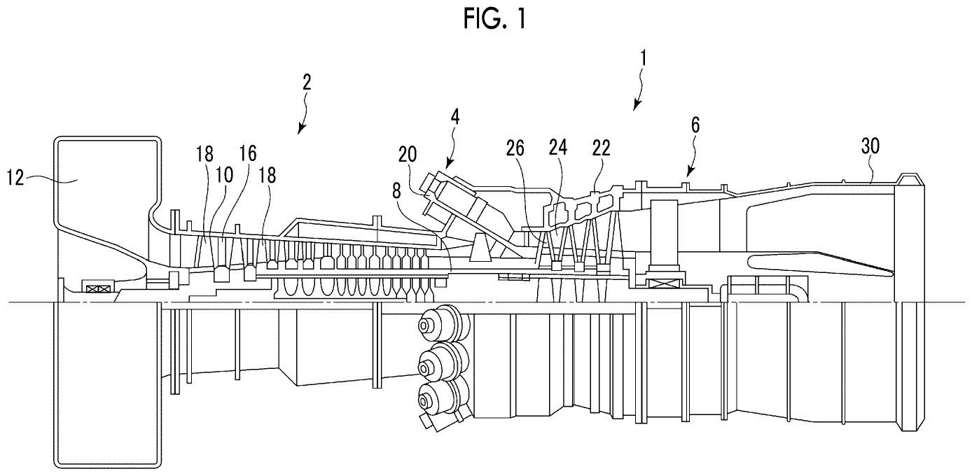

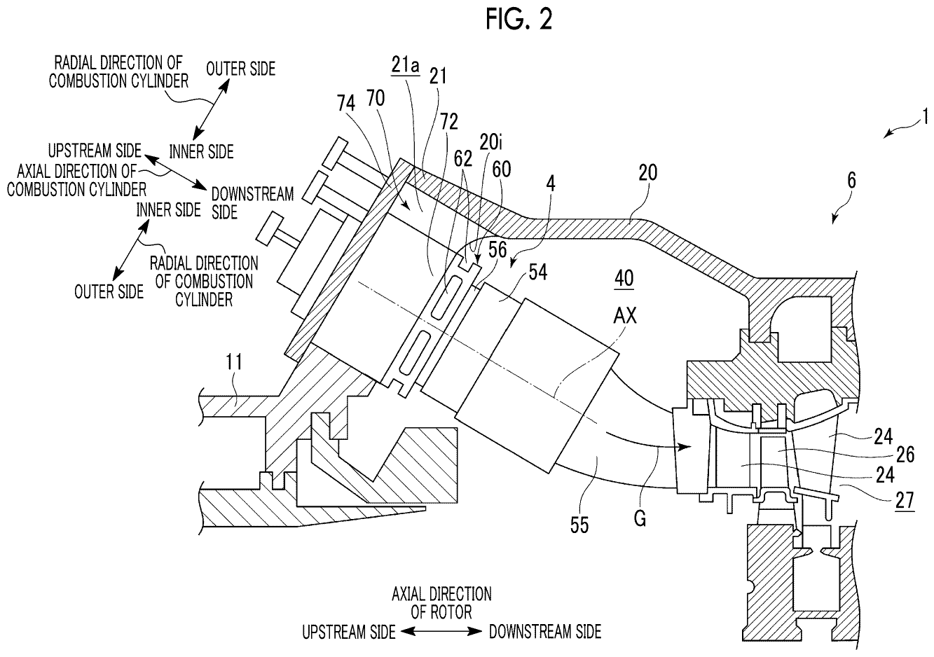

First, a gas turbine, which is an application example of a gas turbine combustor according to some embodiments, will be described with reference to FIGS. 1 and 2. FIG. 1 is a schematic configuration diagram of a gas turbine according to one embodiment. FIG. 2 is a cross-sectional view of a vicinity of a combustor 4.

As shown in FIG. 1, a gas turbine 1 includes a compressor 2 for generating compressed air, the gas turbine combustor (combustor) 4 for generating combustion gas by using the compressed air and fuel, and a turbine 6 configured to be rotationally driven by the combustion gas. In a case of the gas turbine 1 for power generation, a generator (not illustrated) is connected to the turbine 6.

The compressor 2 includes a plurality of stator vanes 16 fixed to a casing 11 of a compressor casing 10 via a vane ring (not illustrated), and a plurality of rotor blades 18 embedded in a rotor 8 to be alternately arranged with respect to the stator vanes 16.

Air taken in from an air intake port 12 is fed to the compressor 2, and the air passes through the plurality of stator vanes 16 and the plurality of rotor blades 18 and is compressed to be high-temperature and high-pressure compressed air.

The fuel and the compressed air generated by the compressor 2 are supplied to the combustor 4, and the fuel is combusted in the combustor 4 to generate a combustion gas G, which is a working fluid of the turbine 6. As shown in FIGS. 1 and 2, the gas turbine 1 includes a plurality of combustors 4, which are disposed along a circumferential direction around the rotor 8, in a casing 20 defining a combustor casing 40.

The compressed air compressed by the compressor 2 is supplied into the combustor casing 40.

The turbine 6 includes a plurality of stator vanes 24 and rotor blades 26 provided in a combustion gas passage 27 in a turbine casing 22. The stator vanes 24 and the rotor blades 26 of the turbine 6 are provided on a downstream side of the combustor 4 with respect to a flow of the combustion gas G (downstream side in axial direction of rotor 8).

In the following description, in relation to the axial direction of the rotor 8, a downstream side in a direction in which the combustion gas G flows in the combustion gas passage 27 is referred to as a downstream side in the axial direction of the rotor 8, and an upstream side in the direction in which the combustion gas G flows in the combustion gas passage 27 is referred to as an upstream side in the axial direction of the rotor 8.

The stator vanes 24 are fixed on a side of the turbine casing 22, and the plurality of stator vanes 24 arranged along the circumferential direction of the rotor 8 configure a stator vane row. Further, the rotor blades 26 are embedded in the rotor 8, and the plurality of rotor blades 26 arranged along the circumferential direction of the rotor 8 configure a rotor blade row. The stator vane rows and the rotor blade rows are alternately arranged in the axial direction of the rotor 8.

In the turbine 6, the combustion gas G from the combustor 4 flowing into the combustion gas passage 27 passes through the plurality of stator vanes 24 and the plurality of rotor blades 26 from the upstream side to the downstream side in the axial direction of the rotor 8, and thus the rotor 8 is rotationally driven. This drives a generator connected to the rotor 8 to generate power. The combustion gas G after driving the turbine 6 is discharged to an outside via an exhaust chamber 30.

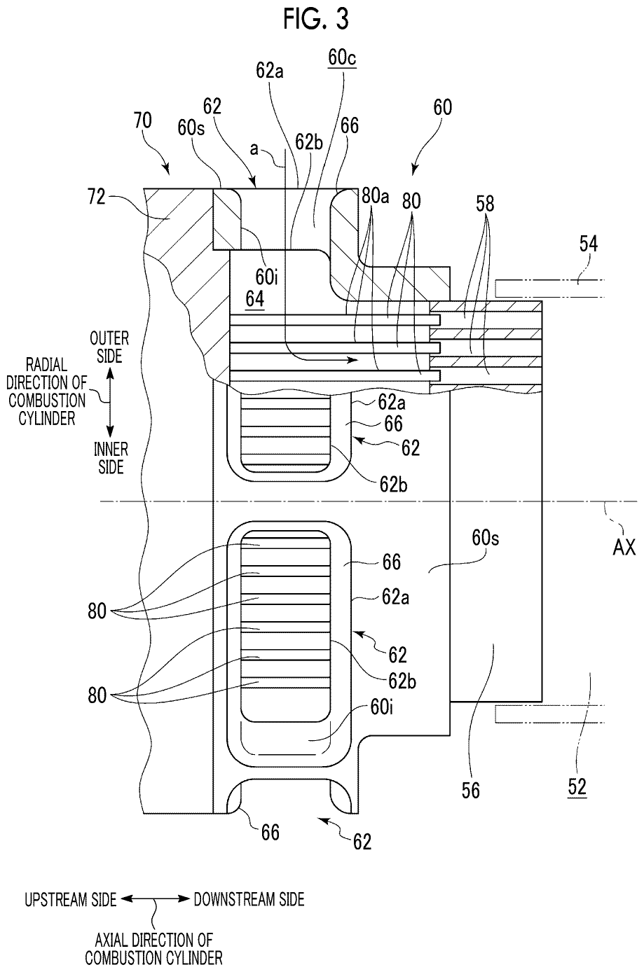

FIG. 3 is a diagram for describing a structure of main parts of the combustor 4 according to some embodiments. As shown in FIGS. 2 and 3, the combustor 4 includes a combustion cylinder 54 that has a combustion chamber 52 therein, an air hole plate 56 that has a plurality of air holes 58 formed therein and that is located on an upstream side of the combustion cylinder 54, a tubular member 60 that is located on a side opposite to the combustion cylinder 54 with respect to the air hole plate 56, and a top hat portion 70 that has a head end portion 72 located on a side opposite to the air hole plate 56 with respect to the tubular member 60.

In the following description, an extending direction of a central axis AX of the combustion cylinder 54 is simply referred to as an axial direction. Further, in relation to the axial direction, a downstream side in a direction in which the combustion gas G flows in the combustion cylinder 54 is referred to as an axial downstream side or simply as a downstream side, and an upstream side in the direction in which the combustion gas G flows in the combustion cylinder 54 is referred to as an axial upstream side or simply as an upstream side. A circumferential direction around the central axis AX of the combustion cylinder 54 is also simply referred to as a circumferential direction.

Further, for the sake of convenience of description, the central axis AX of the combustion cylinder 54 will be extended to the upstream side, and directions of the air hole plate 56, the tubular member 60, and the top hat portion 70 will also be described with reference to the central axis AX of the combustion cylinder 54.

In the combustor 4 according to some embodiments, a transition piece 55 is provided on the downstream side of the combustion cylinder 54. The transition piece 55 may be integrally configured with the combustion cylinder 54.

### Air Hole Plate 56

In the combustor 4 according to some embodiments, the air hole plate 56 is, for example, a member in which a plurality of through-holes extending in a thickness direction of a thick disk-shaped member are formed as the air holes 58. The air hole plate 56 is formed with the plurality of air holes 58 extending in the extending direction of the central axis AX of the combustion cylinder 54.

In the combustor 4 according to some embodiments, the air hole plate 56 is attached to the tubular member 60 described below.

### Tubular Member 60

In the combustor 4 according to some embodiments, the tubular member 60 has an internal space 64 extending in the axial direction therein, and is located on the axial upstream side, which is the side opposite to the combustion cylinder 54 with respect to the air hole plate 56. The tubular member 60 includes an opening 62 that is formed in a side portion 60s of the tubular member 60 and that is for taking in the compressed air (hereinafter, also referred to simply as air) in the combustor casing 40 into the internal space 64.

The opening 62 has a relatively short flow path 60c that extends in a radial direction from an outer-side opening end 62a facing a radial outer side of the tubular member 60 to an inner-side opening end 62b facing a radial inner side of the tubular member 60. The opening 62 has a bell mouth shape in which an inner peripheral surface 60i defining the flow path 60c is formed such that a flow path area decreases from the outer-side opening end 62a toward the radial inner side. That is, the opening 62 has a guide portion 66 for guiding the compressed air flowing into the internal space 64 of the tubular member 60 from a side of the tubular member 60.

A plurality of openings 62 are formed at spacings in the circumferential direction over the entire circumference in a region on the upstream side of the side portion 60s of the tubular member 60.

As described above, the internal space 64 of the tubular member 60 extends in the axial direction, and the opening 62 having the relatively short flow path 60c, which extends in the radial direction, is provided in the region on the upstream side of the side portion 60s. Thus, in a cross-sectional view along the axial direction, the tubular member 60 forms an L-shaped flow path through which the compressed air can flow, the L-shaped flow path being formed by the flow path 60c and the internal space 64.

### Fuel Nozzle 80

In the combustor 4 shown in FIG. 3, a plurality of fuel nozzles 80 are disposed in the internal space 64 of the tubular member 60. The plurality of fuel nozzles 80 are each provided to correspond to the plurality of air holes 58, and each of the plurality of fuel nozzles 80 extends in the axial direction.

### Top Hat Portion 70

In the combustor 4 according to some embodiments, the top hat portion 70 has a head end portion 72 that is located on the axial upstream side of the tubular member 60, and a flange portion 74 that is formed at a position separated from the head end portion 72 on the axial upstream side and that is attached to the casing 20 defining the combustor casing 40 (refer to FIG. 2).

The top hat portion 70 is configured to be located, in a case where the flange portion 74 is attached to the casing 20, at an inlet portion 21 defining a tubular space 21a protruding toward an outside of the combustor casing 40 from an inner peripheral surface 20i of the casing 20 defining the combustor casing 40.

In the combustor 4 configured in this manner, the compressed air in the combustor casing 40 flows into the internal space 64 of the tubular member 60 from the opening 62, and flows toward the plurality of air holes 58 of the air hole plate 56. In this case, as indicated by an arrow a in FIG. 3, the compressed air flows along the flow path 60c of the opening 62 on the radial inner side to flow into the internal space 64, and then a flow direction of the compressed air is changed by 90 degrees toward the axial downstream side and the compressed air flows toward the plurality of air holes 58 of the air hole plate 56.

The compressed air flowing into the internal space 64 flows into the plurality of air holes 58 of the air hole plate 56, and flows toward the downstream side while being mixed, in the plurality of air holes 58, with the fuel injected from the plurality of fuel nozzles 80.

The fuel and the air mixed in the air hole plate 56 are ignited by an ignition device (not illustrated) to form a flame in the combustion chamber 52 in the combustion cylinder 54, thereby generating the combustion gas G.

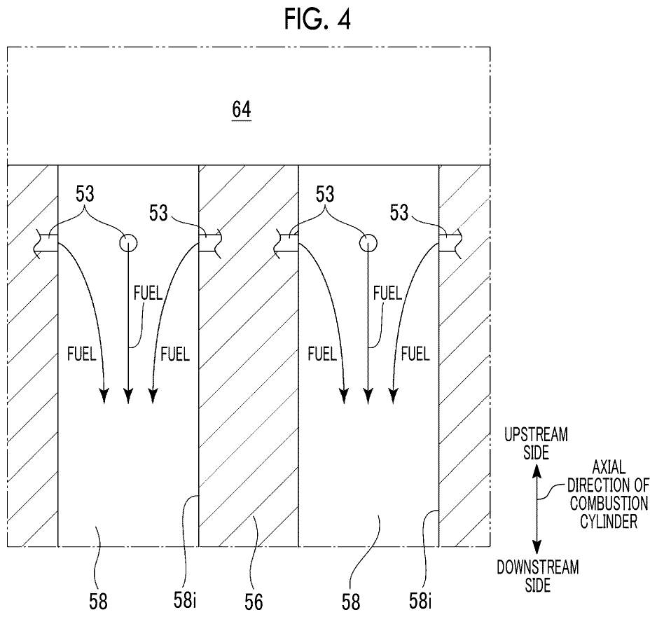

FIG. 4 is a cross-sectional view of the air hole plate 56 of the combustor 4 according to another embodiment.

In the combustor 4 according to another embodiment, a fuel injection hole 53 is provided on an inner peripheral surface 58i of each of the plurality of air holes 58, and the fuel can be injected into the air hole 58 from the fuel injection hole 53.

That is, in the combustor 4 according to some embodiments, instead of the injection of the fuel from the plurality of fuel nozzles 80 disposed in the internal space 64 of the tubular member 60 to each of the plurality of air holes 58, the fuel may be injected into the air hole 58 from the fuel injection hole 53 provided on the inner peripheral surface 58i of each of the plurality of air holes 58.

The combustor 4 according to some embodiments described above may have the following features.

That is, in the combustor 4 according to some embodiments, at least a part of the opening 62 may be configured to be located, in a case where the top hat portion 70 is attached to the casing 20 defining the combustor casing 40, more inside the combustor casing 40 than the inner peripheral surface 20i of the casing 20. In the combustor 4 shown in FIG. 2, the entire opening 62 is configured to be located more inside the combustor casing 40 than the inner peripheral surface 20i of the casing 20.

At least a part of the opening 62 formed in the side portion 60s of the tubular member 60 is located more inside the combustor casing 40 than the inner peripheral surface 20i of the casing 20, and thus it is possible to reduce a flow speed of the compressed air in the combustor casing 40 in a case where the compressed air flows into the opening 62. Further, since the opening 62 is formed in the side portion 60s of the tubular member 60, an opening area of the opening 62 can be relatively easily increased, and thus it is possible to reduce the flow speed of the compressed air in the combustor casing 40 in a case where the compressed air flows into the opening 62. Accordingly, it is possible to reduce a bias in an air flow rate of the compressed air flowing into the plurality of air holes 58 from the internal space 64 of the tubular member 60.

With the gas turbine 1 including the combustor 4 according to some embodiments described above, the bias of the air flow rate of the compressed air flowing into the plurality of air holes 58 from the internal space 64 of the tubular member 60 can be reduced as described above, and thus it is possible to reduce an NOx emission amount and a pressure loss in a case where the compressed air passes through each of the air holes 58, thereby reducing a decrease in efficiency of the entire gas turbine 1.

In the combustor 4 according to some embodiments described above, the opening 62 may be formed at a position closer to the head end portion 72 than the air hole plate 56 in the axial direction. That is, the opening 62 may be formed in the region on the upstream side of the side portion 60s of the tubular member 60, as described above.

In order for the direction of the flow of the compressed air, which flows into the internal space 64 of the tubular member 60 from the side portion 60s of the tubular member 60 via the opening 62, to turn to the axial downstream side, it is desirable that a distance in the axial direction from the opening 62 to the air hole plate 56 is ensured to some extent. With the above configuration, in a case where the opening 62 is formed in the region on the upstream side of the side portion 60s, the distance in the axial direction from the opening 62 to the air hole plate 56 can be made long as compared with a case where the opening 62 is formed in a region on the downstream side of the side portion 60s. Therefore, it is possible to reduce the bias of the air flow rate of the compressed air flowing into the plurality of air holes 58.

In the combustor 4 according to some embodiments described above, the opening 62 may have the guide portion 66 for guiding the air flowing into the internal space 64 of the tubular member 60 from the side of the tubular member 60.

Accordingly, the flow of the compressed air flowing into the internal space 64 of the tubular member 60 is less likely to be disturbed, and thus it is possible to reduce the bias of the air flow rate of the compressed air flowing into the plurality of air holes 58.

In the combustor 4 according to some embodiments described above, the opening 62 may be configured to be located, in a case where the top hat portion 70 is attached to the casing 20, more inside the combustor casing 40 than the inner peripheral surface 20i of the casing 20, as shown in FIG. 2.

Accordingly, it is possible to further reduce the flow speed of the compressed air in the combustor casing 40 in a case where the compressed air flows into the opening 62. Therefore, it is possible to further reduce the bias of the air flow rate of the compressed air flowing into the plurality of air holes 58 from the internal space 64 of the tubular member 60.

In the combustor 4 according to some embodiments described above, the plurality of fuel nozzles 80 that respectively correspond to the plurality of air holes 58 and that extend in the axial direction may be provided. The plurality of fuel nozzles 80 may be disposed in the internal space 64 of the tubular member 60.

Accordingly, it is easier for the compressed air to flow in the axial direction along outer peripheral portions 80a of the plurality of fuel nozzles 80 disposed in the internal space 64 of the tubular member 60.

In the combustor 4 according to some embodiments described above, the tubular member 60 may be attached to the head end portion 72, as shown in FIG. 3.

Accordingly, it is possible to realize, with a simple configuration, support of the tubular member 60 of which at least a part is located in the combustor casing 40.

The top hat portion 70 having the head end portion 72 is attached to the casing by the flange portion 74. Therefore, the tubular member 60 is attached to the casing via the top hat portion 70.

In the combustor 4 according to some embodiments described above, the top hat portion 70 may have the flange portion 74 that is attached to the casing 20. The head end portion 72 may be formed at a position separated from the flange portion 74 in the axial direction toward the tubular member 60, that is, at a position separated from the flange portion 74 on the axial downstream side.

Accordingly, it is possible to bring the tubular member 60 close to the combustor casing 40 separated from the flange portion 74 on the axial downstream side.

In the top hat portion 70, a positional relationship in the axial direction between the flange portion 74 and the head end portion 72 may be defined such that at least a part of the opening 62 of the tubular member 60 attached to the head end portion 72 is located, in a case where the flange portion 74 is attached to the casing 20, more inside the combustor casing 40 than the inner peripheral surface 20i of the casing 20.

Accordingly, it is possible to easily dispose the tubular member 60 such that at least a part of the opening 62 is located more inside the combustor casing 40 than the inner peripheral surface 20i of the casing 20.

The present disclosure is not limited to the embodiments described above, and includes a form in which modifications are added to the embodiments described above or a form in which these embodiments are combined as appropriate.

The contents described in each of the embodiments described above are understood as follows, for example.
(1) A gas turbine combustor 4 according to at least one embodiment of the present disclosure includes a combustion cylinder 54 that has a combustion chamber 52 on an inner side of the combustion cylinder 54; an air hole plate 56 that is formed with a plurality of air holes 58 extending in an axial direction of the combustion cylinder 54 and that is located on an upstream side of the combustion cylinder 54; a tubular member 60 that has an internal space 64 extending in the axial direction inside and that is located on a side opposite to the combustion cylinder 54 with respect to the air hole plate 56; and a top hat portion 70 that has a head end portion 72 located on a side opposite to the air hole plate 56 with respect to the tubular member 60. The tubular member 60 includes an opening 62 that is formed in a side portion 60s of the tubular member 60 and that is for taking in air in a combustor casing 40 into the internal space 64. At least a part of the opening 62 is configured to be located, in a case where the top hat portion 70 is attached to a casing 20 defining the combustor casing 40, more inside the combustor casing 40 than an inner peripheral surface 20i of the casing 20.

With the configuration of (1), since the gas turbine combustor 4 is configured such that at least a part of the opening 62 formed in the side portion 60s of the tubular member 60 is located more inside the combustor casing 40 than the inner peripheral surface 20i of the casing 20, it is possible to reduce the flow speed of the compressed air in the combustor casing 40 in a case where the compressed air flows into the opening 62. Further, since the opening area of the opening 62 can be relatively easily increased, it is possible to reduce the flow speed of the compressed air in the combustor casing 40 in a case where the compressed air flows into the opening 62. Accordingly, it is possible to suppress the separation of the compressed air flowing into the plurality of air holes 58 from the internal space 64 of the tubular member 60, and also to reduce the bias of the air flow rate of the compressed air.
(2) In some embodiments, in the configuration of (1), the opening 62 may be formed at a position closer to the head end portion 72 than the air hole plate 56 in the axial direction.

In order for the direction of the flow of the compressed air, which flows into the internal space 64 of the tubular member 60 from the side portion 60s of the tubular member 60 via the opening 62, to turn to the axial downstream side, it is desirable that a distance in the axial direction from the opening 62 to the air hole plate 56 is ensured to some extent.

With the configuration of (2), since the distance in the axial direction from the opening 62 to the air hole plate 56 can be made long as compared with a case where the opening 62 is formed at a position closer to the air hole plate 56 than the head end portion 72 in the axial direction, it is possible to reduce the bias of the air flow rate of the compressed air flowing into the plurality of air holes 58.
(3) In some embodiments, in the configuration of (1) or (2), the opening 62 may have a guide portion 66 for guiding the air flowing into the internal space 64 of the tubular member 60 from a side of the tubular member 60.

With the configuration of (3), the flow of the compressed air flowing into the internal space 64 of the tubular member 60 is less likely to be disturbed, and thus it is possible to reduce the bias of the air flow rate of the compressed air flowing into the plurality of air holes 58.
(4) In some embodiments, in the configuration of (1) to (3), the opening 62 may be configured to be located, in a case where the top hat portion 70 is attached to the casing 20, more inside the combustor casing 40 than the inner peripheral surface 20i.

With the configuration of (4), it is possible to further reduce the flow speed of the compressed air in the combustor casing 40 in a case where the compressed air flows into the opening 62. Accordingly, it is possible to further reduce the bias of the air flow rate of the compressed air flowing into the plurality of air holes 58 from the internal space 64 of the tubular member 60.
(5) In some embodiments, in the configuration of (1) to (4), a plurality of fuel nozzles 80 that respectively correspond to the plurality of air holes 58 and that extend in the axial direction may be further provided. The plurality of fuel nozzles 80 may be disposed in the internal space 64 of the tubular member 60.

With the configuration of (5), it is easier for the compressed air to flow in the axial direction along outer peripheral portions 80a of the plurality of fuel nozzles 80 disposed in the internal space 64 of the tubular member 60.
(6) In some embodiments, in the configuration of (1) to (5), the tubular member 60 may be attached to the head end portion 72.

With the configuration of (6), it is possible to realize, with a simple configuration, support of the tubular member 60 of which at least a part is located in the combustor casing 40.
(7) In some embodiments, in the configuration of (1) to (6), the top hat portion 70 may have a flange portion 74 that is attached to the casing 20. The head end portion 72 may be formed at a position separated from the flange portion 74 in the axial direction toward the tubular member 60.

With the configuration of (7), it is possible to bring the tubular member 60 close to the combustor casing 40 separated from the flange portion 74 in the axial direction.
(8) A gas turbine 1 according to at least one embodiment of the present disclosure includes the gas turbine combustor 4 having the configuration of (1) to (7), and the casing 20 defining the combustor casing 40.

With the configuration of (8), the bias of the air flow rate of the compressed air flowing into the plurality of air holes 58 from the internal space 64 of the tubular member 60 can be reduced, and thus it is possible to reduce an NOx emission amount and a pressure loss in a case where the compressed air passes through each of the air holes 58, thereby reducing a decrease in efficiency of the entire gas turbine 1.

### REFERENCE SIGNS LIST

1: gas turbine
2: compressor
4: gas turbine combustor (combustor)
6: turbine
8: rotor
20: casing
20i: inner peripheral surface
21: inlet portion
21a: space
40: combustor casing
52: combustion chamber
54: combustion cylinder
56: air hole plate
58: air hole
60: tubular member
60s: side portion
62: opening
64: internal space
66: guide portion
70: top hat portion
72: head end portion
74: flange portion
80: fuel nozzle

1. A gas turbine combustor comprising:
a combustion cylinder that has a combustion chamber on an inner side of the combustion cylinder;
an air hole plate that is formed with a plurality of air holes extending in an axial direction of the combustion cylinder and that is located on an upstream side of the combustion cylinder;
a tubular member that has an internal space extending in the axial direction inside and that is located on a side opposite to the combustion cylinder with respect to the air hole plate; and
a top hat portion that has a head end portion located on a side opposite to the air hole plate with respect to the tubular member,
wherein the tubular member includes an opening that is formed in a side portion of the tubular member and that is for taking in air in a combustor casing into the internal space, and
at least a part of the opening is configured to be located, in a case where the top hat portion is attached to a casing defining the combustor casing, more inside the combustor casing than an inner peripheral surface of the casing.

2. The gas turbine combustor according to claim 1,
wherein the opening is formed at a position closer to the head end portion than the air hole plate in the axial direction.

3. The gas turbine combustor according to claim 1,
wherein the opening has a guide portion for guiding the air flowing into the internal space of the tubular member from a side of the tubular member.

4. The gas turbine combustor according to claim 1,
wherein the opening is configured to be located, in a case where the top hat portion is attached to the casing, more inside the combustor casing than the inner peripheral surface.

5. The gas turbine combustor according to claim 1, further comprising:
a plurality of fuel nozzles that respectively correspond to the plurality of air holes and that extend in the axial direction,
wherein the plurality of fuel nozzles are disposed in the internal space of the tubular member.

6. The gas turbine combustor according to claim 1,
wherein the tubular member is attached to the head end portion.

7. The gas turbine combustor according to claim 1,
wherein the top hat portion has a flange portion that is attached to the casing, and
the head end portion is formed at a position separated from the flange portion in the axial direction toward the tubular member.

8. A gas turbine comprising:
the gas turbine combustor according to claim 1; and
the casing defining the combustor casing.
